(19) United States
(12) Patent Application Publication
(10) Pub. No.: US 2012/0133146 A1
(43) Pub. Date: May 31, 2012

(54) DETECTING APPARATUS FOR DETECTING LIGHTNING STRIKE, WIND TURBINE BLADE EQUIPPED WITH THE SAME, WIND TURBINE GENERATOR, METHOD FOR DETECTING LIGHTNING STRIKE

(75) Inventors: Takehiro NAKA, Tokyo (JP); Kentaro HAYASHI, Tokyo (JP); Musashi KIMURA, Tokyo (JP); Nobuyasu NAKAMURA, Tokyo (JP); Takatoshi MATSUSHITA, Tokyo (JP); Yoichiro TSUMURA, Tokyo (JP); Atsushi YUGE, Tokyo (JP)

(73) Assignee: MITSUBISHI HEAVY INDUSTRIES, LTD., Tokyo (JP)

(21) Appl. No.: 13/308,303

(22) Filed: Nov. 30, 2011

(30) Foreign Application Priority Data
Nov. 30, 2010 (JP) 2010-267715

(51) Int. Cl. G01W 1/00; F03D 9/00

(52) U.S. Cl. 290/55; 73/170.24

(57) ABSTRACT

A lightning-strike detecting apparatus comprises: receptors (lightning members) that are provided at a plurality of locations on a wind turbine blade; lightning conductors that extend from these receptors to guide lightning-strike current to ground; a plurality of optical-fiber current sensors that are provided on the respective lightning conductors, detect lightning-strike current flowing in the lightning conductors, and output an optical signal; an optical signal converter that receives the individual optical signal output from these optical-fiber current sensors, converts the optical signals to the respective characteristic electrical signals, and outputs the electrical signals; and a controller that identifies the type of the electrical signal input from the optical signal converter, determines a lightning-strike spot on the basis of the type, and reports the lightning-strike spots.

### CROSS-REFERENCE TO RELATED APPLICATIONS

This application is based on Japanese Patent Application No. 2010-267715, the contents of which are incorporated herein by reference.

### BACKGROUND OF THE INVENTION

1. Field of the Invention

The present invention relates to a lightning-strike detecting apparatus that determines the presence/absence of a lightning strike and a lightning-strike location by detecting lightning current flowing in a lightning conductor extending from a lightning discharge member; to a wind turbine rotor blade and wind turbine generator equipped with the same; to a lightning-strike detecting method; and to a lightning-strike detection program.

2. Description of Related Art

Standard wind turbine generators are equipped with a wind turbine rotor blade having several wind turbine blades that extend in radial directions centered on a rotor head and have a configuration in which the rotor head is supported, at a shaft thereof, by a nacelle that is supported at the top of a tower so as to be capable of turning horizontally, and a generator disposed inside the nacelle is driven by the rotation of this wind turbine rotor blade to perform electrical power generation.

This kind of wind turbine generator tends to be struck by lightning particularly on portions of the wind turbine blades, and therefore, receptors (earthing members) serving as lightning discharger devices are provided on each wind turbine blade, as disclosed in Japanese Unexamined Patent Application, Publication No. 2010-223148. In addition to the tips of the blades, which tend to be struck by lightning the most, the receptors are provided at several locations on the respective parts of the wind turbine blades, and lightning conductors (down conductors) extend from the respective receptors, which then pass through the interior of the wind turbine blades and are earthed to the ground via the nacelle and the tower. Therefore, lightning current that occurs when lightning strikes the receptors is guided into the ground, thereby preventing the wind turbine blades from being damaged.

In addition, in recent years, discrete metal pieces called diverter strips have been bonded on the blade surface in addition to the receptors so as to be able to allow lightning-strike current that occurs when lightning strikes areas other than the receptors to flow along the surface of the wind turbine blades via the individual diverter strips and to guide the lightning-strike current into the receptors. By doing so, the lightning conductor need not be provided on the respective diverter strips, and it is possible to improve the lightning resistance of the wind turbine blades with a simple configuration.

However, the receptors, the diverter strips, and so forth fail to fully protect the wind turbine blades from many lightning strikes, and lightning strikes often cause damage to the wind turbine blades. Because serious accidents may be caused if the damage caused to the wind turbine blades due to lightning strikes is not identified and operation is continued without taking any countermeasures, it is essential to find and repair the damage due to lightning strikes immediately. In addition, even if the damage is not serious enough to require repairs, it is very important to know the energy level of the lightning strikes and the locations of lightning strikes on the wind turbine blades in order to perform maintenance of the wind turbine blades and to take measures against future lightning strikes.

A disclosed conventional lightning-strike detecting apparatus specifies a wind turbine blade that has been struck by lightning by detecting lightning current with a large-diameter Rogowski coil disposed on the tower of the wind turbine generator, as disclosed in the Publication of Japanese Patent No. 4211924 and by measuring lightning-strike currents with small-diameter Rogowski coils disposed on the respective blade roots of a plurality of the wind turbine blades, as disclosed in Japanese Unexamined Patent Application, Publication No. 2009-203893.

However, although the conventional technologies disclosed in the Publication of Japanese Patent No. 4211924 and Japanese Unexamined Patent Application, Publication No. 2009-203893 mentioned above can detect a lightning strike or measure lightning-strike current on the whole wind turbine generator or on the individual wind turbine blades, it is difficult to detect which part of the wind turbine blade has been struck by lightning, and therefore, it has been difficult to perform immediate repairs. Although a lightning-strike spot can be specified if it is possible to provide numerous devices that electrically detect lightning current, such as Rogowski coils, on the wind turbine blades, because Rogowski coils are expensive and difficult to install, the overall configuration of the lightning-strike detecting apparatus becomes complex and expensive, which leads to an increased cost for constructing wind turbine generators. Furthermore, because Rogowski coils measure lightning current with a metallic signal wire, they have drawbacks in that they tend to be adversely affected by surges and noise due to lightning strikes and that they have low reliability.

### BRIEF SUMMARY OF THE INVENTION

The present invention has been conceived in light of the circumstances described above, and an object thereof is to provide a lightning-strike detecting apparatus that can determine the occurrence of a lightning strike and a lightning-strike spot reliably with a simple, inexpensive, and highly reliable configuration, and to provide a wind turbine rotor blade and wind turbine generator equipped with the same.

In order to solve the problems described above, the present invention employs the following solutions.

A first aspect of a lightning-strike detecting apparatus according to the present invention includes: a lightning discharge member; a lightning conductor that extends from the lightning discharge member to guide lightning-strike current to ground; an optical-fiber current sensor that is provided on the lightning conductor, detects the lightning-strike current flowing in the lightning conductor, and outputs an optical signal; an optical signal converting unit that receives the optical signal output from the optical-fiber current sensor, converts the optical signal to an electrical signal, and outputs the electrical signal; and a control unit that receives the electrical signal output from the optical signal converting unit, detects a lightning strike, and informs a manager of the lightning strike.

According to the first aspect, when the lightning discharge member is struck by lightning, the lightning-strike current thereof flows in the lightning conductor, the lightning-strike current is detected by the optical-fiber current sensor, and the optical-fiber current sensor then outputs the optical signal to the optical signal converting unit. The optical signal converting unit converts the received optical signal into an electrical signal and outputs this electrical signal to the control unit. By receiving the electrical signal, the control unit determines that there has been a lightning strike and informs the manager that there has been a lightning strike. Therefore, the manager can immediately be notified that lightning has struck a structure such as the wind turbine generator etc. and he/she can start work such as shutdown of devices, inspection, or repair of damaged portions promptly.

Because the optical-fiber current sensor has a simple structure, is inexpensive, is easy to install on the lightning conductor, and can detect lightning-strike current without using a metallic signal wire such as a Rogowski coil etc., the optical-fiber current sensor is less prone to adverse effects due to lightning strikes, such as surging and noise. Therefore, it is possible to increase the reliability of the lightning-strike detecting apparatus.

In addition, a second aspect of a lightning-strike detecting apparatus according to the present invention is a lightning-strike detecting apparatus wherein, in the first aspect, the lightning discharge member, the lightning conductor, and the optical-fiber current sensor are respectively disposed at a plurality of locations; the optical signal converting unit receives the optical signal output from the a plurality of optical-fiber current sensors individually, converts a plurality of the optical signals to the respective characteristic electrical signals, and outputs them to the control unit; and the control unit identifies the type of the electrical signal input from the optical signal converting unit, determines a lightning-strike spot in accordance with the identified type, and reports the lightning-strike spot.

According to the second aspect, because a plurality of the optical-fiber current sensors are provided in correspondence with a plurality of the lightning discharge members disposed at respective parts of the structure etc., these optical-fiber current sensors can output different optical signals to the optical signal converting unit in accordance with the lightning-strike spot. The optical signal converting unit converts these optical signals into respective characteristic electrical signals and outputs the electrical signals to the control unit. The control unit can specify the optical-fiber current sensor that has detected a lightning-strike current in accordance with the type of the electrical signal input from the optical signal converting unit and can distinguish which portion of the structure etc. has been struck by lightning in accordance with location information of the lightning discharge member that corresponds to the optical-fiber current sensor.

Because the optical-fiber current sensor is inexpensive, even if numerous optical-fiber current sensors are disposed together with the lightning discharge members and the lightning conductors, the increase in the cost is small. Therefore, even if numerous lightning discharge members are provided, the optical-fiber current sensors can be provided in correspondence with the respective lightning discharge members, and a lightning-strike location can be accurately distinguished with an inexpensive configuration.

In addition, a third aspect of a lightning-strike detecting apparatus according to the present invention is a lightning-strike detecting apparatus wherein, in the first aspect, a plurality of the optical-fiber current sensors are provided for one unit of the lightning conductor.

According to the third aspect, when lightning strikes the lightning discharge member provided at the tip end of the lightning conductor, because all of the plurality of optical-fiber current sensors detect the lightning-strike current flowing in the lightning conductor and respectively output the optical signal, the control unit can distinguish that lightning has struck the lightning discharge member. In addition, when lightning has struck the intermediate portion of the lightning conductor, but not the lightning discharge member, only some of the plurality of optical-fiber current sensors provided on the same lightning conductor detect the lightning-strike current flowing in the lightning conductor, and it is possible to distinguish the lightning-strike spot, the presence/absence of damage, and so forth by comparing the detection situation.

Therefore, even with a simple configuration in which, for example, the lightning discharge member is provided at only one location at the distal end of the wind turbine blade and only one lightning conductor extends from this lightning discharge member, it is possible to distinguish a situation in which lightning has struck the lightning discharge member at the distal end of the wind turbine blade and a situation in which lightning has struck the intermediate portion of the wind turbine blade. In particular, because a situation in which lightning has struck the intermediate portion of the wind turbine blade and lightning-strike current has flowed in the lightning conductor that is arranged inside the wind turbine blade that the outer coating of the wind turbine blade has been damaged, it is possible to immediately detect damage due to a lightning strike with a simple configuration.

In addition, a fourth aspect of a lightning-strike detecting apparatus according to the present invention is a lightning-strike detecting apparatus wherein, in the first aspect, one unit of the optical-fiber current sensor is provided for a plurality of the lightning conductors.

According to the fourth aspect, even if a plurality of lightning discharge members and lightning conductors are provided, because they can be monitored through one optical-fiber current sensor, when a plurality of lightning discharge members are provided close together, for example, it is possible to simplify the configuration of the lightning-strike detecting apparatus by reducing the number of optical-fiber current sensors to be provided.

In addition, a fifth aspect of a lightning-strike detecting apparatus according to the present invention is a lightning-strike detecting apparatus wherein, in the first aspect, one unit of the optical-fiber current sensor is continuously wound around the two units of the lightning conductors in opposite winding directions, thereby allowing a positive optical signal to be output from the optical-fiber current sensor when a lightning-strike current flows in one of the two lightning conductors, and allowing a negative optical signal to be output from the optical-fiber current sensor when a lightning-strike current flows in the other of the two lightning conductors; the optical signal converting unit outputs a positive or negative electrical signal in accordance with the sign of the optical signal received from the optical-fiber current sensor; and the control unit determines a lightning-strike spot by distinguishing, in accordance with the sign of the electrical signal, in which of the two lightning conductors the lightning-strike current has flowed.

According to the fifth aspect, it is possible to distinguish in which of the two lightning conductors the lightning-strike current has flowed, in other words, which of the two lightning discharge members has been struck by lightning, with one optical-fiber current sensor, and therefore, it is possible to reduce the number of the optical-fiber current sensors to be provided to half of the number of the lightning discharge members provided. By doing so, it is possible to simplify the configuration of the lightning-strike detecting apparatus by reducing the number of optical-fiber current sensors to be provided by half without compromising the ability to identify the lightning-strike spot.

In addition, a sixth aspect of a lightning-strike detecting apparatus according to the present invention is a lightning-strike detecting apparatus wherein, in the first aspect, the optical-fiber current sensor is covered by an insulating covering material of the lightning conductor. Accordingly, it is possible to simplify the process of installing the optical-fiber current sensor and to increase the durability and reliability of the lightning-strike detecting apparatus by protecting the optical-fiber current sensor with the insulating covering material.

In addition, a seventh aspect of a lightning-strike detecting apparatus according to the present invention is a lightning-strike detecting apparatus wherein, in the first aspect, the optical-fiber current sensor and an optical-fiber strain sensor that determines the strain of an object located in the vicinity of the optical-fiber current sensor are continuously formed by the same optical fiber cable.

According to the seventh aspect, because the optical-fiber current sensor and the optical-fiber strain sensor are formed with the same optical fiber cable, the optical-fiber current sensor and the optical-fiber strain sensor can share the same optical fiber cable, and therefore, the configurations of both the lightning-strike detecting apparatus and the strain detector can be simplified.

In addition, an eighth aspect of a lightning-strike detecting apparatus according to the present invention further includes, in the first aspect: an image-acquisition unit that starts image-acquisition on the basis of at least one of a lightning strike determination result and reported information of a lightning strike obtained from the control unit and outputs an image-acquisition result.

According to the eighth aspect, because image-acquisition is started when a lightning strike is detected, the image-acquisition result is helpful for ascertaining damage etc. caused by the lightning.

In addition, a ninth aspect of a lightning-strike detecting apparatus according to the present invention further includes, in the eighth aspect: a storing unit that stores the image-acquisition result before a lightning strike; and a damage determining unit that compares the image-acquisition result after a lightning strike has been detected and the image-acquisition result before the lightning strike, which is read out from the storing unit, and determines the presence/absence of damage due to the lightning strike.

As described above, by comparing the image-acquisition results before and after the lightning strike, it is possible to conveniently determine the presence/absence of damage due to a lightning strike.

In addition, a tenth aspect of a lightning-strike detecting apparatus according to the present invention further includes, in the second aspect: an image-acquisition unit that starts image-acquisition of the lightning-strike spot on the basis of information about the lightning-strike spot obtained from the control unit and outputs the image-acquisition result.

As described above, by performing the image-acquisition while focusing on the lightning-strike spot, it is possible to promptly obtain the image-acquisition result of the lightning-strike spot.

In addition, an eleventh aspect of a lightning-strike detecting apparatus according to the present invention further includes, in the tenth aspect: a storing unit that stores the image-acquisition result of the lightning-strike spot before a lightning strike and a damage determining unit that compares the image-acquisition result of the lightning-strike spot after a lightning strike has been detected and the image-acquisition result of the lightning-strike spot before the lightning strike, which is read out from the storing unit, and determines the presence/absence of damage due to the lightning strike.

As described above, by comparing the image-acquisition results before and after the lightning strike, it is possible to conveniently determine the presence/absence of damage due to the lightning strike.

In addition, a wind turbine rotor blade according to the present invention is equipped with the lightning-strike detecting apparatus of the first aspect. Accordingly, it is possible to determine the presence/absence of a lightning strike to the wind turbine rotor blade and the lightning-strike spot with a simple, inexpensive, and highly reliable configuration.

In addition, a wind turbine rotor blade according to the present invention is equipped with the lightning-strike detecting apparatus of the second aspect. Accordingly, it is possible to determine the presence/absence of a lightning strike to the wind turbine rotor blade and the lightning-strike spot with a simple, inexpensive, and highly reliable configuration.

A wind turbine generator according to the present invention is equipped with the wind turbine rotor blade. Accordingly, it is possible to determine the presence/absence of a lightning strike to the wind turbine rotor blade of the wind turbine generator and the lightning-strike spot with a simple, inexpensive, and highly reliable configuration.

A first aspect of a lightning-strike detecting method according to the present invention is a lightning-strike detecting method for a lightning-strike detecting apparatus that includes: a lightning discharge member; a lightning conductor that extends from the lightning discharge member to guide lightning-strike current to ground; and an optical-fiber current sensor that is provided on the lightning conductor, detects the lightning-strike current flowing in the lightning conductor, and outputs an optical signal, wherein the lightning-strike detecting method includes: an optical signal conversion step that receives the optical signal, converts the optical signal to an electrical signal, and outputs the electrical signal and a control step that receives the electrical signal, determines a lightning strike, and informs a manager of a lightning strike.

A first aspect of a lightning-strike detection program according to the present invention is a lightning-strike detection program for a lightning-strike detecting apparatus that includes: a lightning discharge member; a lightning conductor that extends from the lightning discharge member to guide lightning-strike current to ground; and an optical-fiber current sensor that is provided on the lightning conductor, detects the lightning-strike current flowing in the lightning conductor, and outputs an optical signal; wherein the lightning-strike detection program executes: optical signal conversion processing that receives the optical signal, converts the optical signal to an electrical signal, and outputs the electrical signal; and control processing that receives the electrical signal, detects a lightning strike, and informs a manager of a lightning strike.

### BRIEF DESCRIPTION OF THE SEVERAL VIEWS OF THE DRAWINGS

FIG. 1 is a front view showing an example of a wind turbine generator equipped with wind turbine blades to which a lightning-strike detecting apparatus according to a first embodiment of the present invention is applied.

FIG. 2 is a block diagram showing, in outline, the configuration of a lightning-strike detecting apparatus showing the first embodiment of the present invention.

FIG. 3 is a perspective view of a lightning-strike detecting apparatus showing the first embodiment of the present invention.

FIG. 4 is a perspective view of a lightning-strike detecting apparatus showing a second embodiment of the present invention.

FIG. 5 is a perspective view of a lightning-strike detecting apparatus showing a third embodiment of the present invention.

FIG. 6 is a perspective view of a lightning-strike detecting apparatus showing a fourth embodiment of the present invention.

FIG. 7A is a diagram showing current values when lightning-strike current is detected using counterclockwise winding for the winding direction of an optical-fiber current sensor in the fourth embodiment.

FIG. 7B is a diagram showing current values when lightning-strike current is detected using clockwise winding for the winding direction of an optical-fiber current sensor in the fourth embodiment.

FIG. 8 is a perspective view of a lightning conductor and optical-fiber current sensor showing a fifth embodiment of the present invention.

FIG. 9 is a configuration diagram of a lightning-strike detecting apparatus showing a sixth embodiment of the present invention.

FIG. 10 is a block diagram showing, in outline, the configuration of a lightning-strike detecting apparatus showing a seventh embodiment of the present invention.

FIG. 11 is a diagram for explaining an azimuth angle.

### DETAILED DESCRIPTION OF THE INVENTION

Embodiments of a wind turbine generator according to the present invention will be described below based on the drawings.

### First Embodiment

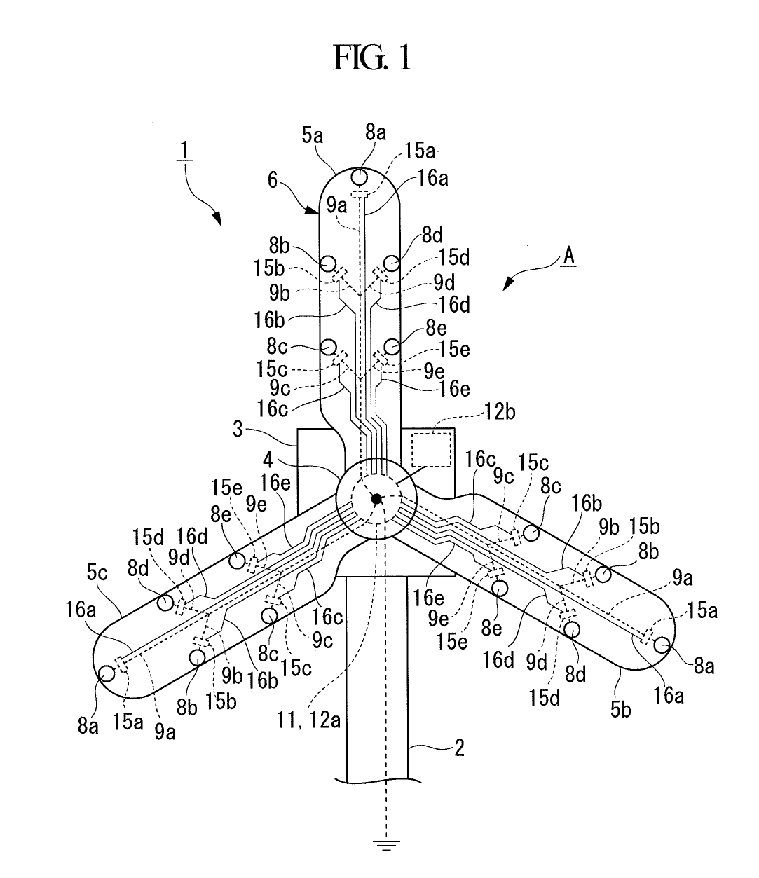

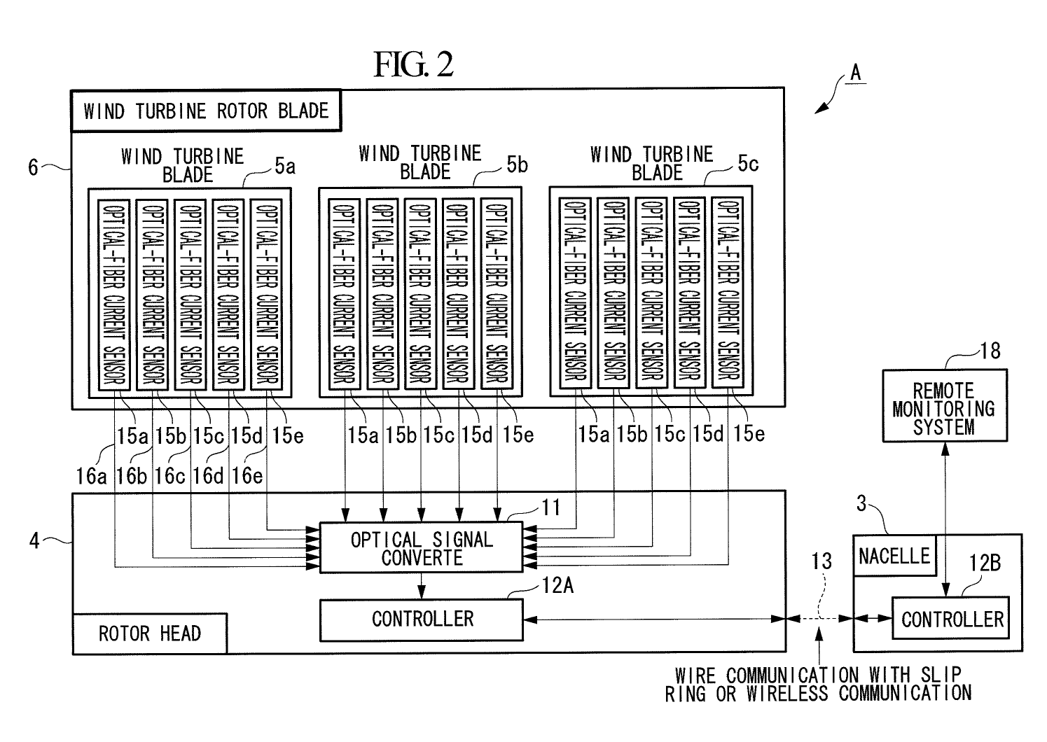

FIG. 1 is a front view showing an example of a wind turbine generator equipped with a wind turbine rotor blade to which a lightning-strike detecting apparatus A according to the present invention is applied. In addition, FIG. 2 is a block diagram showing, in outline, the configuration of the lightning-strike detecting apparatus A.

This wind turbine generator 1 includes a tower 2 disposed upright on, for example, the ground, ocean, or the like, a nacelle 3 disposed at the top end of the tower 2, and a rotor head 4 supported on the front end of the nacelle 3 so as to be freely rotatable around a rotational axis in an approximately horizontal transverse direction. A plurality of (e.g., three) radially extending wind turbine blades 5a, 5b, and 5c are attached to the rotor head 4 to form a wind turbine rotor blade 6, a generator (not shown) is accommodated inside the nacelle 3, and a rotor shaft of the rotor head 4 is connected to a main shaft of the above-mentioned generator via a gear box. Thus, the wind force of external wind striking the wind turbine blades 5a to 5c is converted into a rotation force that rotates the wind turbine rotor blade 6 and the rotor shaft to drive the generator, thus generating electricity.

The nacelle 3 can turn together with the wind turbine rotor blade 6 in the horizontal direction at the top end of the tower 2 and is controlled by a driving device and a controller (not shown) so as to always point upwind, thereby efficiently generating electricity. In addition, pitch angles of the wind turbine blades 5a to 5c are automatically adjusted such that the wind turbine rotor blade 6 is rotated most efficiently in accordance with the wind speed. The nacelle 3 and the wind turbine blades 5a to 5c, etc. are formed by, for example, FRP molding.

Each of the three wind turbine blades 5a to 5c is provided with a receptor 8a at the distal end thereof and the receptors 8b, 8c, 8d, and 8e at two locations each on the edge portions at both sides. A plurality of the receptors 8a to 8e, which are known lightning discharge members, are generally formed in a circular shape with a diameter of several centimeters, or in a shape following the form of the blade tip, and are bonded to the surface of the wind turbine blades 5a to 5c with an adhesive etc. Lightning conductors (down conductors) 9a to 9e extending from the respective receptors 8a to 8e through the interior of the wind turbine blades 5a to 5c to the blade root side are earthed to the ground via the nacelle 3 and the tower 2. Lightning current occurring when lightning strikes the respective receptors 8a to 8e is thereby guided into the ground. Although the lightning conductors 9b to 9e are branched from the lightning conductor 9a extending from the receptor 8a in this embodiment, each of the lightning conductors 9a to 9e may be arranged independently.

An optical signal converter 11 and a controller 12A, which are also shown in FIG. 2, are installed inside the rotor head 4. In addition, a controller 12B is installed inside the nacelle 3. The controller 12B is connected to the optical signal converter 11 and the controller 12A via a signal communication path 13 using a slip ring (not shown), for example. The slip ring is a known electrical connecting member that electrically links the rotor head 4, which is a rotating member, and the nacelle 3, which is a fixed member. Wireless communication may be employed instead of wired communication using such a slip ring.

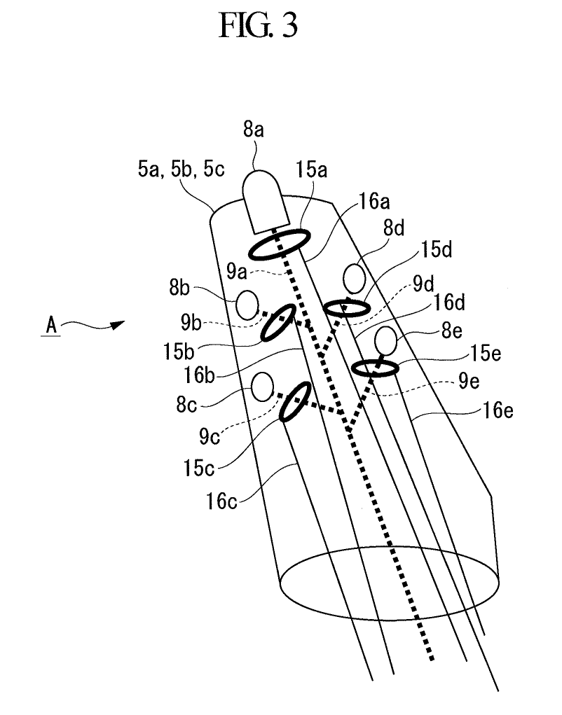

As shown in FIG. 3, the lightning conductors 9a to 9e extending from the respective receptors 8a to 8e are provided with optical-fiber current sensors 15a to 15e, respectively. These optical-fiber current sensors 15a to 15e are optical fiber members formed in a ring-shape surrounding the respective lightning conductors 9a to 9e. In addition, optical fiber cables 16a to 16e extend from the respective optical-fiber current sensors 15a to 15e, and these optical fiber cables 16a to 16e pass through, together with the lightning conductors 9a to 9e, the interior of the wind turbine blades 5a to 5c and are individually connected to the optical signal converter 11 in the rotor head 4.

Thus, the lightning-strike detecting apparatus A is configured with a total of fifteen units of the optical-fiber current sensors 15a to 15e that are attached to the receptors 8a to 8e on the three wind turbine blades 5a to 5c, the optical fiber cables 16a to 16e extending therefrom, the optical signal converter 11, and a remote monitoring system 18 (see FIG. 2) disposed at a location remote from the controllers 12A and 12B and the wind turbine generator 1.

The optical-fiber current sensors 15a to 15e are sensors that determine current values by detecting magnetic fields generated around the lightning conductors 9a to 9e when lightning current flows in the lightning conductors 9a to 9e in the event of a lightning strike to the receptors 8a to 8e. In other words, the optical-fiber current sensors 15a to 15e detect the Faraday effect, that is rotation of the plane of polarization of light in proportion to a magnetic field, caused when light passes through a transparent medium disposed in a magnetic field, and output characteristic optical signals, and these optical signals are individually received by the optical signal converter 11 via the optical fiber cables 16a to 16e.

The optical signal converter 11 converts the optical signals received from the respective optical-fiber current sensors 15a to 15e into fifteen types of characteristic electrical signals corresponding to all of the optical-fiber current sensors 15a to 15e and outputs these electrical signals to the controller 12A. The controller 12A identifies, together with the controller 12B, which of the fifteen units of the optical-fiber current sensors 15a to 15e has detected the lightning-strike current in accordance with the type of the electrical signal input from the optical signal converter 11, thereby determines the lightning-strike spot, calculates the current value of the lightning current by processing the electrical signal, and outputs the information to the remote monitoring system 18.

By doing so, because information such as the fact that lightning has struck, the lightning-strike spot, the scale of the lightning strike, and so forth is reported to a manager of the wind turbine generator 1, the manager can immediately stop the operation of the wind turbine generator 1 and start work such as inspection and repairs promptly.

Because this lightning-strike detecting apparatus A is configured such that fifteen units of the optical-fiber current sensors 15a to 15e are provided corresponding to the receptors 8a to 8e disposed at fifteen locations in total on the wind turbine rotor blade 6, these fifteen units of the optical-fiber current sensors 15a to 15e are connected to the optical signal converter 11 via the respective optical fiber cables 16a to 16e, and the respective optical-fiber current sensors 15a to 15e output characteristic optical signals to the optical signal converter 11, the controllers 12A and 12B can identify which of the fifteen units of the optical-fiber current sensors 15a to 15e has output the optical signal and, as a result, can accurately determine which part of the wind turbine rotor blade 6 has been struck by lightning.

Because the optical-fiber current sensors 15a to 15e have a simple structure and are inexpensive, they are easily disposed on the lightning conductors 9a to 9e. Thus, even if the optical-fiber current sensors 15a to 15e are disposed in numbers similar to those of the receptors 8a to 8e and the lightning conductors 9a to 9e, the increase in the cost is small. Therefore, the lightning-strike location on the wind turbine rotor blade 6 can be accurately distinguished with a simple and inexpensive configuration.

Furthermore, because the optical-fiber current sensors 15a to 15e can detect lightning-strike currents without using a metallic signal wire like a Rogowski coil, which is conventionally employed for detecting lightning current, the optical-fiber current sensors 15a to 15e are less prone to adverse effects due to lightning strikes, such as surges and noise. Therefore, the reliability of the lightning-strike detecting apparatus A can be greatly improved. More than fifteen units of the optical-fiber current sensors 15a to 15e may be provided to improve the precision of identifying the lightning-strike location, or less than fifteen units of the optical-fiber current sensors 15a to 15e may be provided to simplify the configuration further. In addition, the receptors, the lightning conductors, and the optical-fiber current sensors may be provided not only on the wind turbine blades 5a to 5c but also on the nacelle 3 etc. In addition, the diverter strips may be employed in combination with the receptors.

### Second Embodiment

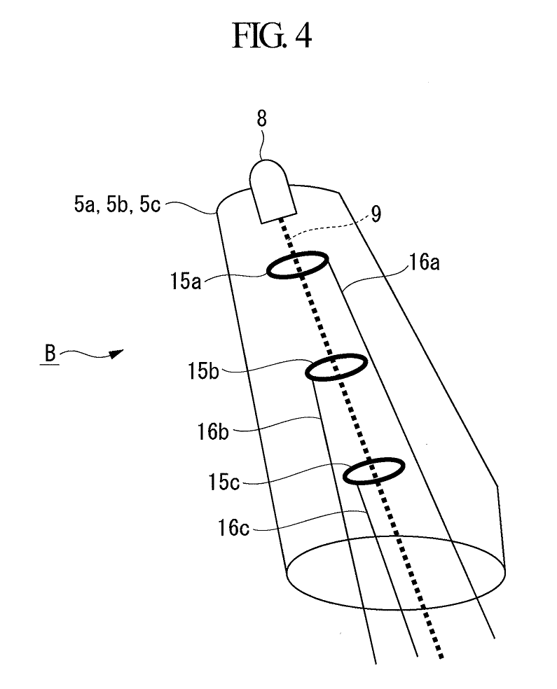

FIG. 4 is a perspective view of a lightning-strike detecting apparatus B showing a second embodiment of the present invention. In this embodiment, one unit of the receptor 8 is disposed only at the distal end of the wind turbine blades 5a to 5c, and three units, for example, of the optical-fiber current sensors 15a to 15c are disposed on one lightning conductor 9 extending from this receptor 8 to the blade root side. The optical fiber cables 16a, 16b, and 16c extending from the respective optical-fiber current sensors 15a to 15c are, similarly to the lightning-strike detecting apparatus A in the first embodiment, arranged together with the lightning conductor 9 inside the wind turbine blades 5a to 5c and connected to an optical signal converter that is installed inside the rotor head (not shown). The function of the optical-fiber current sensors 15a to 15c is the same as that in the lightning-strike detecting apparatus A. In addition, although not shown in the figure, similarly to the lightning-strike detecting apparatus A, the lightning-strike detecting apparatus B is equipped with an optical signal converter, a controller, and a remote monitoring system.

According to the thus-configured lightning-strike detecting apparatus B, if lightning strikes the receptor 8 provided at the tip end of the lightning conductor 9, all three units of the optical-fiber current sensors 15a to 15c detect the lightning-strike current flowing in the lightning conductor 9 and individually output optical signals; therefore, the controller can distinguish that lightning has struck the receptor 8. In addition, if lightning strikes the intermediate portion of the lightning conductor 9 but not the receptor 8, only some of the three units of the optical-fiber current sensors 15a to 15c provided on the same lightning conductor 9 detect the lightning-strike current flowing in the lightning conductor 9, and the controllers 12A and 12B can distinguish the lightning-strike spot, the presence/absence of damage, and so forth by comparing the detected conditions.

Therefore, as in this embodiment, even with a simple lightning discharger device configuration in which the receptor 8 is provided at only one location at the distal ends of the wind turbine blades 5a to 5c and only one lightning conductor 9 extends from this receptor 8, it is possible to distinguish a situation in which lightning has struck the receptor 8 at the distal ends of the wind turbine blades 5a to 5c and a situation in which lightning has struck an intermediate portion of the wind turbine blades 5a to 5c. In particular, because a situation in which lightning has struck an intermediate portion of the wind turbine blades 5a to 5c and the lightning-strike current has flowed in the lightning conductor 9 that is arranged inside the wind turbine blades 5a to 5c means that the outer coating of the wind turbine blades 5a to 5c has been damaged, it is possible to immediately detect the damage due to a lightning strike with a simple configuration.

### Third Embodiment

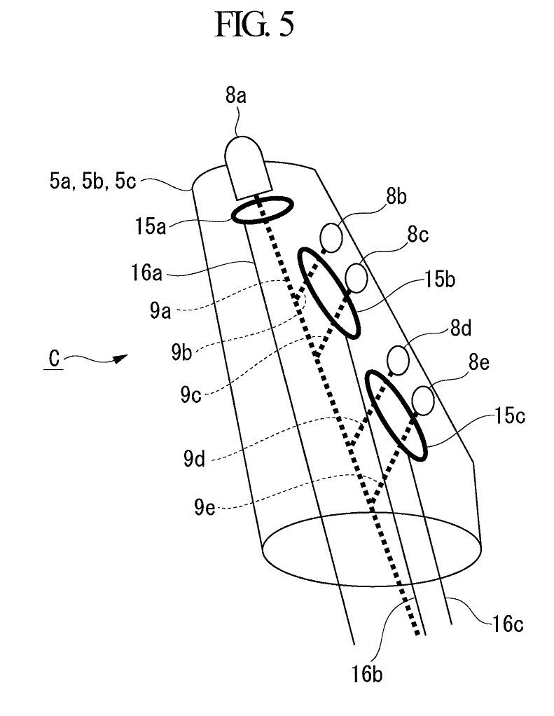

FIG. 5 is a perspective view of a lightning-strike detecting apparatus C showing a third embodiment of the present invention. In this embodiment, a total of five units of receptors 8a to 8e are disposed at the distal end and the intermediate portions of the wind turbine blades 5a to 5c, and the lightning conductors 9b, 9c, 9d, and 9e connected to the other receptors 8b to 8e are branched from the lightning conductor 9a extending from the receptor 8a provided at the distal end to the blade root side. A dedicated optical-fiber current sensor 15a is disposed on the lightning conductor 9a, a shared optical-fiber current sensor 15b is disposed on the lightning conductors 9b and 9c, and similarly, a shared optical-fiber current sensor 15c is disposed on the lightning conductors 9d and 9e. The optical fiber cables 16a, 16b, and 16c extending from the respective optical-fiber current sensors 15a, 15b, and 15c are arranged, together with the lightning conductors 9a, inside the wind turbine blades 5a to 5c and are connected to an optical signal converter (not shown).

As described above, because one unit of the optical-fiber current sensor 15b is disposed in such a manner that two lightning conductors 9b and 9c are bundled together, and similarly, because one unit of the optical-fiber current sensor 15c is disposed in such a manner that two lightning conductors 9d and 9e are bundled together, the lightning strike to the two units of the receptors 8b and 8c can be monitored by one unit of the optical-fiber current sensor 15b, and similarly, a lightning strike to the two units of the receptors 8d and 8e can be monitored by one unit of the optical-fiber current sensor 15c. Therefore, as in this embodiment, when a plurality of receptors 8b and 8c, and 8d and 8e are provided close to each other, it is possible to simplify the configuration of the lightning-strike detecting apparatus C with a small number of optical-fiber current sensors 15a to 15c.

### Fourth Embodiment

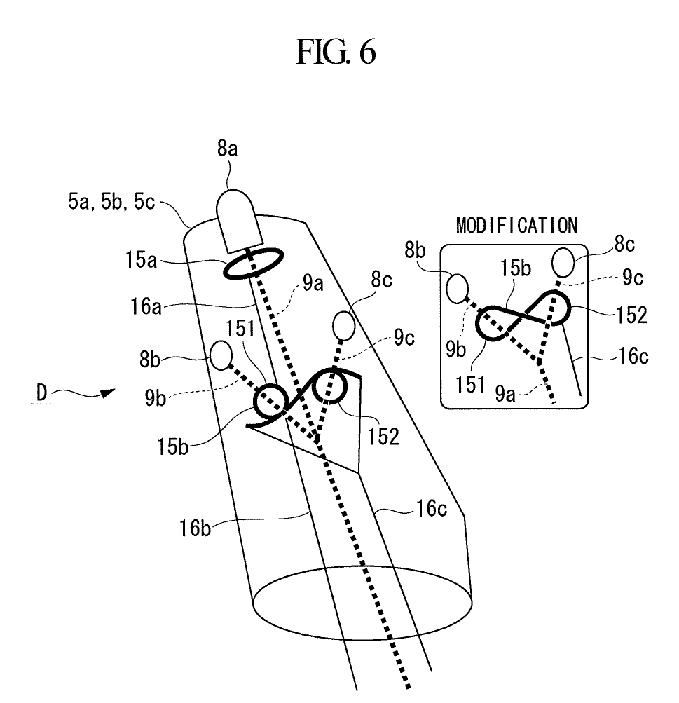

FIG. 6 is a perspective view of a lightning-strike detecting apparatus D showing a fourth embodiment of the present invention. In this embodiment, a total of three units of receptors 8a, 8b, and 8c are disposed at the distal ends and the intermediate portions of the wind turbine blades 5a to 5c, and the lightning conductors 9b and 9c connected to the other receptors 8b and 8c are branched from the lightning conductor 9a extending from the receptor 8a provided at the distal end to the blade root side. A dedicated optical-fiber current sensor 15a is disposed on the lightning conductor 9a, and a shared optical-fiber current sensor 15b is disposed on the lightning conductors 9b and 9c. The optical fiber cables 16a and 16b extending from the respective optical-fiber current sensors 15a and 15b are arranged, together with the lightning conductor 9a, inside the wind turbine blades 5a to 5c and are connected to an optical signal converter (not shown).

The optical-fiber current sensor 15b is a flexible rod, but not a ring, and is continuously wound around the two lightning conductors 9b and 9c in opposite winding directions.

In other words, the optical-fiber current sensor 15b has a ring portion 151 that is wound around the lightning conductor 9b and a ring portion 152 that is wound around the lightning conductor 9c. The respective ring portions 151 and 152 have opposite winding directions to each other. For example, if the ring portion 151 is wound counterclockwise, then the ring portion 152 is wound clockwise. As shown in a modification illustrated at the right-hand side in FIG. 6, the counterclockwise ring portion 151 that is wound around the lightning conductor 9b and the clockwise ring portion 152 that is wound around the lightning conductor 9c may be formed by making the optical-fiber current sensor 15b into a ring and twisting this ring of the optical-fiber current sensor 15b so as to form figure-eight shapes.

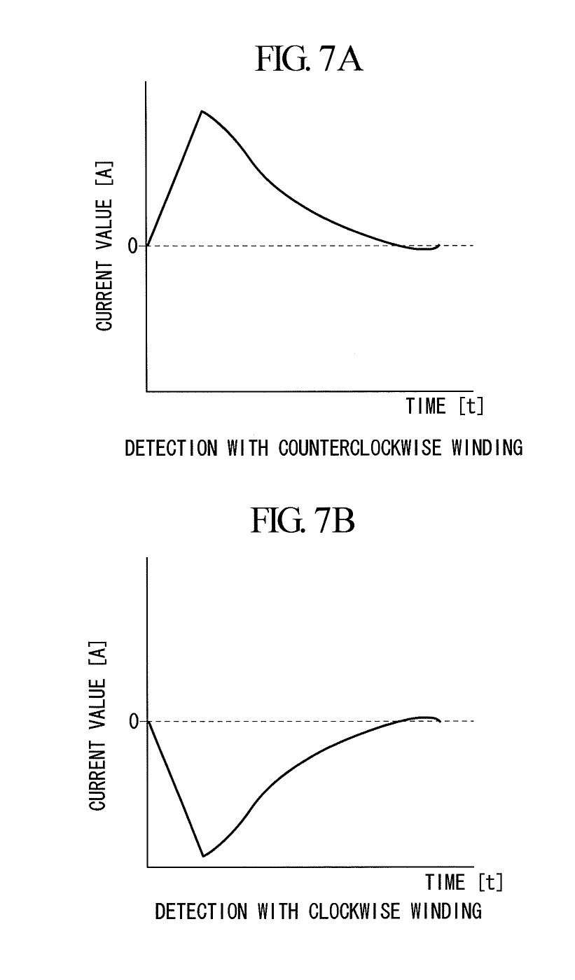

By doing so, when one receptor 8b is struck by lightning, the lightning current caused thereby flows in the lightning conductor 9b; therefore, the lightning current is detected by the counterclockwise ring portion 151 of the optical-fiber current sensor 15b. In this case, a positive optical signal is output from the optical-fiber current sensor 15b, and as shown in FIG. 7A, the electrical signal output from the optical signal converter upon receiving this has a positive value, for example.

In addition, when the other receptor 8c is struck by lightning, the lightning current caused thereby flows in the lightning conductor 9c; therefore, the lightning current is detected by the clockwise ring portion 152 of the optical-fiber current sensor 15b. In this case, a negative optical signal is output from the optical-fiber current sensor 15b, and as shown in FIG. 7B, the electrical signal output from the optical signal converter upon receiving this has a negative value.

Thus, the controller can distinguish in which of the two lightning conductors 9b and 9c the lightning-strike current has flowed, in other words, which of the receptors 8b and 8c has been struck by lightning, in accordance with the sign of the electrical signal output from the optical signal converter.

With this lightning-strike detecting apparatus D, because the lightning-strike currents flowing in the two lightning conductor 9b and 9c can be monitored individually by using one unit of the optical-fiber current sensor 15b, the number of optical-fiber current sensors to be provided can be reduced to half of the number of receptors provided. By doing so, it is possible to simplify the configuration of the lightning-strike detecting apparatus D by reducing the number of optical-fiber current sensors to be provided by half without compromising the ability to identify the lightning-strike spot.

### Fifth Embodiment

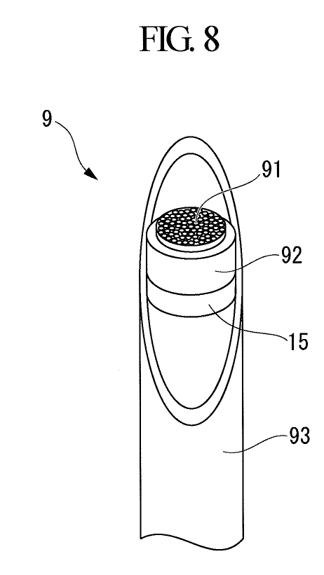

FIG. 8 is a perspective view of the lightning conductor 9 and the optical-fiber current sensor 15 showing a fifth embodiment of the present invention. As shown in this figure, the lightning conductor 9 has a core wire 91 that is an electrical conductor having an adequate gauge for allowing lightning current, which is a high-voltage direct current, to flow therethrough, and the periphery of the core wire 91 is covered by two layers of insulating covering materials 92 and 93. Then, the optical-fiber current sensor 15 is provided so as to be installed inside the lightning conductor 9. In other words, the optical-fiber current sensor 15 is wound around the outer periphery of the insulating covering material 92 so as not to be in direct contact with the core wire 91, and then the surface thereof is covered by the insulating covering material 93.

As described above, by covering the optical-fiber current sensor 15 with the insulating covering material 93 of the lightning conductor 9 and incorporating the optical-fiber current sensor 15 into the lightning conductor 9, it is possible to simplify the process of installing the optical-fiber current sensor 15 and to increase the durability and reliability of the lightning-strike detecting apparatus by protecting the optical-fiber current sensor 15 with the insulating covering material 93.

### Sixth Embodiment

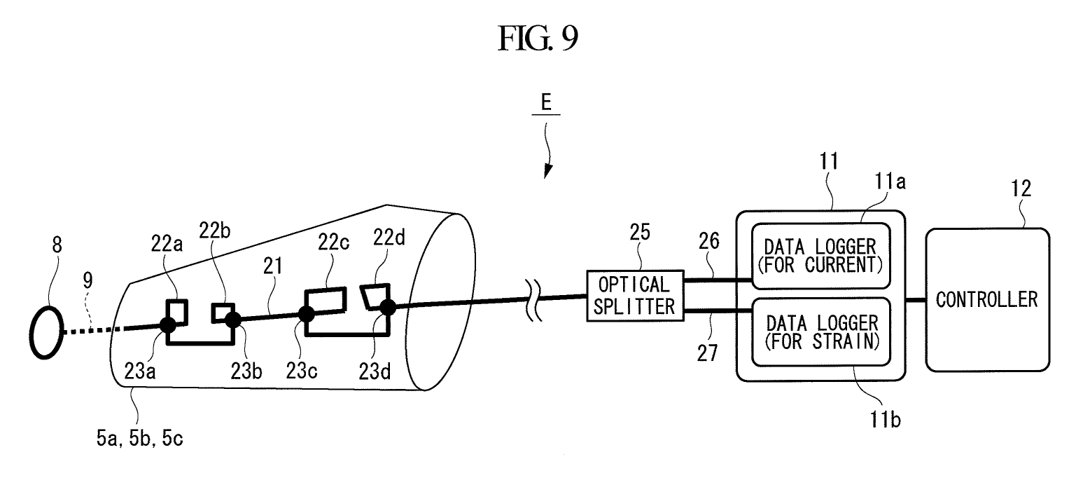

FIG. 9 is a configuration diagram of a lightning-strike detecting apparatus E showing a sixth embodiment of the present invention. In this lightning-strike detecting apparatus E, optical-fiber current sensors 22a to 22d that detect lightning-strike current flowing in the lightning conductor 9 and optical-fiber strain sensors 23a to 23d that determine the strain of objects located in the vicinity of the optical-fiber current sensors 22a to 22d, such as the lightning conductor 9, the wind turbine blades 5a to 5c, and so forth, are continuously formed by the same optical fiber cable 21.

Because the lightning conductors 9 are thick, heavy electrical cables and are always subjected to centrifugal force due to the rotation of the wind turbine blades 5a to 5c, detachment or loosening of fixation of the lightning conductors 9 can be detected immediately by measuring the strain by providing the optical-fiber strain sensors 23a to 23d on the lightning conductors 9.

In addition, when the strain of the wind turbine blades 5a to 5c is measured by using optical fibers, the FBG method is desirably employed for the measurement. In other words, the method calculates the strain in accordance with the variation in the wavelength by utilizing a property whereby, when incident light is radiated onto the optical fiber on which a diffraction grating (sensor part) has been created with ultraviolet radiation, light is reflected at the above-mentioned diffraction grating, and the wavelength of the reflected light varies if strain is caused in the optical fiber. Accordingly, it is possible to evaluate the load distribution over the entire blade.

With the lightning-strike detecting apparatus E of the sixth embodiment, for example, the optical fiber cables 21 are arranged so as to follow the lightning conductors 9 extending from the receptors 8 disposed at the distal ends of the wind turbine blades 5a to 5c to the blade root side, and these optical fiber cables 21 are arranged such that their intermediate portions are wound in loops at four locations to form the optical-fiber current sensors 22a to 22d, and that the lightning conductors 9 pass through these loop-shaped optical-fiber current sensors 22a to 22d. When lightning current flows in the lightning conductor 9, the Faraday effect occurs in the respective optical-fiber current sensors 22a to 22d, and the optical signal is output.

On the other hand, the portions of the optical fiber cable 21 other than the optical-fiber current sensors 22a to 22d are arranged so as to follow the lightning conductor 9, and the crossing parts of the loop-shaped optical-fiber current sensors 22a to 22d are fixed to the lightning conductor 9 to form the optical-fiber strain sensors 23a to 23d. If strain is caused in the lightning conductor 9, the light transmittance in the optical-fiber strain sensors 23a to 23d in close proximity thereto changes, causing an optical signal for strain detection to flow in the optical fiber cable 21. It is possible to detect the strain caused in the wind turbine blades 5a to 5c by fixing these optical-fiber strain sensors 23a to 23d to the inner surfaces of the wind turbine blades 5a to 5c.

The root portion side of the optical fiber cable 21 is connected to an optical splitter 25, and a lightning-current detecting optical fiber 26 that allows the optical signal for detecting lightning current to flow therethrough and a strain-detecting optical fiber 27 that allows the optical signal for detecting the strain to flow therethrough extend from this optical splitter 25. The lightning-current detecting optical fiber 26 is connected to a lightning-current detecting data logger 11a provided in the interior of the optical signal converter 11, and the strain-detecting optical fiber 27 is connected to a strain-detecting data logger 11b similarly provided in the interior of the optical signal converter 11. The controller 12 connected to the optical signal converter 11 distinguishes between information about a lightning strike and information about the strain in the lightning conductor 9 (or the wind turbine blades 5a to 5c) in accordance with the type of signal input from the lightning-current detecting data logger 11a or the strain-detecting data logger 11b.

As described above, by continuously forming the optical-fiber current sensors 22a to 22d and the optical-fiber strain sensors 23a to 23d with the same optical fiber cable 21, the optical-fiber current sensors 22a to 22d and the optical-fiber strain sensors 23a to 23d can share the same optical fiber cable, and therefore, the configurations of both the lightning-strike detecting apparatus E and the strain detector can be simplified.

### Seventh Embodiment

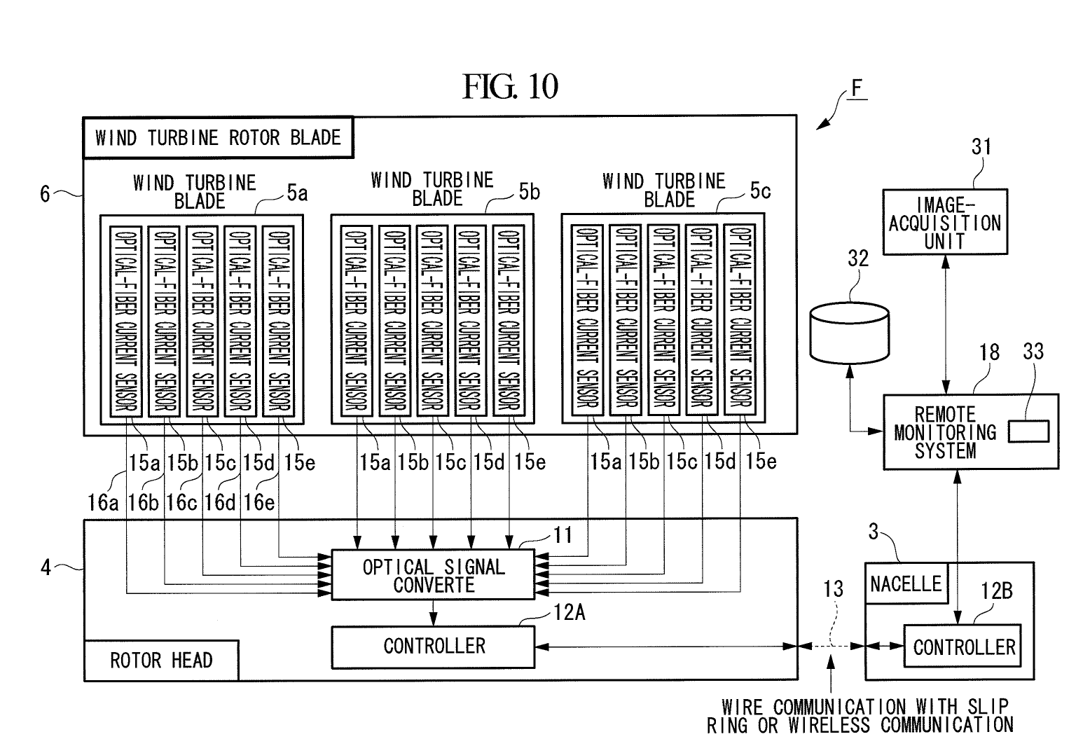

FIG. 10 is a configuration diagram of a lightning-strike detecting apparatus F showing a seventh embodiment of the present invention. This lightning-strike detecting apparatus F differs from the first to sixth embodiments mentioned above in that the lightning-strike detecting apparatus F is equipped with an image-acquisition unit 31 and a database (storing unit) 32 in addition to the configuration of the lightning-strike detecting apparatus A shown in FIG. 1. In the following description of the lightning-strike detecting apparatus F according to this embodiment, descriptions of parts that are the same as those in the first to sixth embodiments will be omitted, and the differences will be mainly described.

The image-acquisition unit 31 starts image-acquisition of the lightning-strike spot and outputs an image-acquisition result to the remote monitoring system 18 on the basis of at least one of a determination result of a lightning strike and reported information of a lightning strike obtained from the controllers 12A and 12B. The image-acquisition unit 31 is, for example, a monitoring camera that acquires moving images of the lightning-strike spot of the wind turbine rotor blade 6 as the image-acquisition result as it starts the image-acquisition and outputs the image-acquisition result to the remote monitoring system 18. In addition, the image-acquisition unit 31 zooms in on the basis of a prescribed standard for determining whether zoom-in is required or zooms in on the basis of a command for magnified display that is input externally by a manager etc., and in order to display the lightning-strike spot and the surrounding area thereof in a magnified manner, the image-acquisition unit 31 changes the focal distance and obtains a magnified image-acquisition result.

The image-acquisition unit 31 may be arranged at a location that allows image-acquisition of a lightning-strike spot, and for example, the image-acquisition unit 31 may be provided on the wind turbine generator 1 or in the vicinity of the wind turbine generator 1. In addition, one unit of the image-acquisition unit 31 may be provided for one unit of a wind turbine generator or for a plurality of wind turbine generators.

In this embodiment, although an example in which a monitoring camera is used as the image-acquisition unit 31 will be described, the embodiment is not limited thereto. For example, other cameras, such as a general video camera etc., may be used in place of the monitoring camera to obtain the image-acquisition result. In addition, the image-acquisition result is not limited to a moving image and it may be a still image.

The database 32 stores the image-acquisition result before a lightning strike and the image-acquisition result after a lightning strike has been detected. The image-acquisition result before a lightning strike is a still image or moving image that can be obtained by image-acquisition of the wind turbine rotor blade 6 with the image-acquisition unit 31 under conditions where there has been no lightning strike, for example, at the time of initial installation, maintenance, normal operation, and so forth. On the other hand, the image-acquisition result after a lightning strike has been detected is a still image or moving image that can be obtained by acquiring an image of the wind turbine rotor blade 6 by the image-acquisition unit 31 after lightning has struck.

The remote monitoring system 18 is a device that is disposed at a location remote from the wind turbine generator 1 and is used by a manager for monitoring a lightning-strike detection result. The remote monitoring system 18 is equipped with an output device, such as a display, a printer, and so forth, which shows the lightning-strike detection result to the manager, and a communication device etc. that performs communication with outside equipment to send/receive information. The remote monitoring system 18 outputs the image-acquisition result obtained from the image-acquisition unit 31 to the output device and outputs the image-acquisition result to the database 32. In addition, the remote monitoring system 18 is equipped with a damage determining unit 33.

The damage determining unit 33 compares the image-acquisition result of the lightning-strike spot after a lightning strike has been detected and the image-acquisition result that corresponds to the area in the vicinity of the lightning-strike spot before a lightning strike, which is read out from the database 32, and determines the presence/absence of damage due to a lightning strike. Specifically, the damage determining unit 33 determines that damage has been caused by estimating that cracking, burnout, separation, or the like has been caused when the degree of change in the compared image-acquisition results is greater than the prescribed amount. A change in this context means, for example, a visually noticeable change, such as a change in blade shape, the state of irregularities on the blade surface, color, and so forth.

When the damage determining unit 33 determines that damage has been caused, it issues an alarm (for example, a screen display, audio notification, and so forth) to the output device of the remote monitoring system 18 and the wind turbine generator 1 stays halted. On the other hand, when the damage determining unit 33 determines that no damage has been caused, it restarts the wind turbine generator 1 via the controller 12.

The controllers 12A and 12B output a wind turbine blade command value such that the image-acquisition result obtained by the image-acquisition unit 31 includes the lightning-strike spot in a desirable degree to control the pitch angle, azimuth angle, and so forth of the wind turbine blades 5a to 5c. By adjusting the pitch angle and the azimuth angle in this way, it is possible to obtain a desirable image-acquisition result from the image-acquisition unit 31.

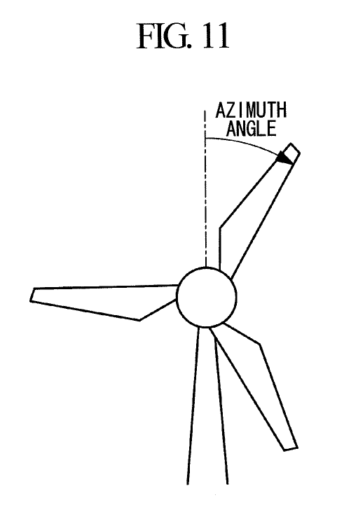

As shown in FIG. 11, the azimuth angle means an angle formed between a prescribed reference and the wind turbine rotor blade 6 in the plane of rotation of the wind turbine rotor blade 6, and in this embodiment, the reference is set to be the timing at which the wind turbine rotor blade 6 is located at the highest part. Therefore, the azimuth angle is 0° when the wind turbine rotor blade 6 is located at the highest part of the wind turbine, and the azimuth angle is 180° when it is located at the lowest part.

The operation of a lightning-strike detecting apparatus according to this embodiment, a wind turbine rotor blade, and a wind turbine generator equipped with the same will be described below.

The image-acquisition unit 31 is provided on the wind turbine generator 1 or in the vicinity of the wind turbine generator 1, an image of the wind turbine rotor blade 6 before a lightning strike is acquired by the image-acquisition unit 31, and the image-acquisition result is output to the remote monitoring system 18. The remote monitoring system 18 outputs the image-acquisition result before a lightning strike to the database 32 and stores the image-acquisition result before the lightning strike in the database 32. In the case where a lightning strike to the wind turbine rotor blade 6 is detected, if the wind turbine generator 1 is being operated, the controllers 12A and 12B stop the operation.

When the controller 12 determines that there is a lightning-strike spot, the controller 12 outputs the command for magnified display that enables magnified display of the lightning-strike spot and the vicinity of the lightning-strike spot to the image-acquisition unit 31 via the remote monitoring system 18. The image-acquisition unit 31 then zooms in on the desired region of the wind turbine blades 5a to 5c on the basis of the command for magnified display obtained from the controller 12 to perform image-acquisition and outputs the image-acquisition result to the remote monitoring system 18. When a manager monitors the image-acquisition result displayed on the output device of the remote monitoring system 18 and determines that the region assumed to be the lightning-strike spot is not included in a prescribed region, the manager inputs a command for adjusting at least one of the pitch angle and the azimuth angle of the wind turbine blades 5a to 5c. The command for adjusting the pitch angle, the azimuth angle, and so forth of the wind turbine blades 5a to 5c is output to a device that controls the wind turbine rotor blade 6 via the controller 12, and the wind turbine rotor blade 6 is controlled. Image-acquisition of the wind turbine rotor blade 6 at the location after the adjustment is performed by the image-acquisition unit 31, and the image-acquisition result is output to the remote monitoring system 18.

With the remote monitoring system 18, the image-acquisition result of the wind turbine blades 5a to 5c before a lightning strike that corresponds to the lightning strike region is read out from the database 32 on the basis of the obtained image-acquisition result. The damage determining unit 33 compares the image-acquisition result after lightning strike has been detected and the image-acquisition result before a lightning strike that is read out from the database 32 and determines the presence/absence of damage on the wind turbine rotor blade 6 due to a lightning strike. If the wind turbine rotor blade 6 is determined to be not damaged by a lightning strike, the wind turbine generator 1 is restarted, and if the wind turbine rotor blade 6 is determined to be damaged, an alert is shown on the output device of the remote monitoring system 18, and the wind turbine generator 1 stays halted.

As described above, by comparing the image-acquisition results before and after a lightning strike, it is possible to conveniently determine the presence/absence of damage due to a lightning strike. In addition, by performing image-acquisition while focusing on the lightning-strike spot, the image-acquisition result of the lightning-strike spot is readily obtained, and it is possible to determine the presence/absence of damage due to a lightning strike more accurately.

The above-mentioned lightning-strike detecting apparatus according to the first to seventh embodiments may have a configuration in which all or a part of the processing mentioned above is processed using separate software. In this case, the lightning-strike detecting apparatus is equipped a CPU, main memory such as RAM etc., and a computer-readable storage medium in which a program for realizing all or a part of the processing mentioned above is stored. The CPU reads out the program stored in the above-mentioned storage medium and executes information processing/arithmetic processing, thereby realizing similar processing to that in the above-described lightning-strike detecting apparatus.

The computer-readable storage medium in this context means a magnetic disk, magneto-optical disk, CD-ROM, DVD-ROM, semiconductor memory, and so forth. In addition, this computer program may be delivered to a computer via a communication line, and the program may be executed by the computer which receiving the delivered program.

As described above, by applying the lightning-strike detecting apparatuses A to F of the first to seventh embodiments described above to the wind turbine rotor blade 6, the nacelle 3, or the like, it is possible to determine the presence/absence of a lightning strike to the wind turbine generator 1 and the lightning-strike spot with a configuration that is simple, inexpensive, and highly reliable.

The embodiments of the present invention are not limited only to the above-mentioned first to seventh embodiments. For example, the first to seventh embodiments may be suitably combined. In addition, a lightning-strike detecting apparatus according to the present invention can be applied not only to a wind turbine rotor blade of a wind turbine generator, but also to a wind turbine rotor blade of other types, and furthermore, it can be widely applied not only to a wind turbine generator, but also to other buildings, moving objects, and so forth.

What is claimed is:

1. A lightning-strike detecting apparatus comprising:
a lightning discharge member;
a lightning conductor that extends from the lightning discharge member to guide lightning-strike current to ground;
an optical-fiber current sensor that is provided on the lightning conductor, detects the lightning-strike current flowing in the lightning conductor, and outputs an optical signal;
an optical signal converting unit that receives the optical signal output from the optical-fiber current sensor, converts the optical signal to an electrical signal, and outputs the electrical signal; and
a control unit that receives the electrical signal output from the optical signal converting unit, detects a lightning strike, and informs a manager of the lightning strike.

2. A lightning-strike detecting apparatus according to claim 1 wherein,
the lightning discharge member, the lightning conductor, and the optical-fiber current sensor are respectively disposed at a plurality of locations;
the optical signal converting unit receives the optical signal output from the a plurality of optical-fiber current sensors individually, converts a plurality of the optical signals to the respective characteristic electrical signals, and outputs them to the control unit; and
the control unit identifies the type of the electrical signal input from the optical signal converting unit, determines a lightning-strike spot in accordance with the identified type, and reports the lightning-strike spot.

3. A lightning-strike detecting apparatus according to claim 1 wherein,
a plurality of the optical-fiber current sensors are provided for one unit of the lightning conductor.

4. A lightning-strike detecting apparatus according to claim 1 wherein,
one unit of the optical-fiber current sensor is provided for a plurality of the lightning conductors.

5. A lightning-strike detecting apparatus according to claim 1 wherein,
one unit of the optical-fiber current sensor is continuously wound around the two units of the lightning conductors in opposite winding directions, thereby allowing a positive optical signal to be output from the optical-fiber current sensor when a lightning-strike current flows in one of the two lightning conductors, and allowing a negative optical signal to be output from the optical-fiber current sensor when a lightning-strike current flows in the other of the two lightning conductors;
the optical signal converting unit outputs a positive or negative electrical signal in accordance with the sign of the optical signal received from the optical-fiber current sensor; and
the control unit determines a lightning-strike spot by distinguishing, in accordance with the sign of the electrical signal, in which of the two lightning conductors the lightning-strike current has flowed.

6. A lightning-strike detecting apparatus according to claim 1 wherein,
the optical-fiber current sensor is covered by an insulating covering material of the lightning conductor.

7. A lightning-strike detecting apparatus according to claim 1 wherein,
the optical-fiber current sensor and an optical-fiber strain sensor that determines the strain of an object located in the vicinity of the optical-fiber current sensor are continuously formed by the same optical fiber cable.

8. A lightning-strike detecting apparatus according to claim 1, further comprising:
an image-acquisition unit that starts image-acquisition on the basis of at least one of a lightning strike determination result and reported information of a lightning strike obtained from the control unit and outputs an image-acquisition result.

9. A lightning-strike detecting apparatus according to claim 8, further comprising:
a storing unit that stores the image-acquisition result before a lightning strike; and
a damage determining unit that compares the image-acquisition result after a lightning strike has been detected and the image-acquisition result before the lightning strike, which is read out from the storingunit, and determines the presence/absence of damage due to the lightning strike.

10. A lightning-strike detecting apparatus according to claim 2, further comprising:
an image-acquisition unit that starts image-acquisition of the lightning-strike spot on the basis of information about the lightning-strike spot obtained from the control unit and outputs the image-acquisition result.

11. A lightning-strike detecting apparatus according to claim 10, further comprising:
a storing unit that stores the image-acquisition result of the lightning-strike spot before a lightning strike; and
a damage determining unit that compares the image-acquisition result of the lightning-strike spot after a lightning strike has been detected and the image-acquisition result of the lightning-strike spot before the lightning strike, which is read out from the storingunit, and determines the presence/absence of damage due to the lightning strike.

12. A wind turbine rotor blade comprising the lightning-strike detecting apparatus according to claim 1.

13. A wind turbine rotor blade comprising the lightning-strike detecting apparatus according to claim 2.

14. A wind turbine generator comprising the wind turbine rotor blade according to claim 12.

15. A wind turbine generator comprising the wind turbine rotor blade according to claim 13.

16. A lightning-strike detecting method for a lightning-strike detecting apparatus equipped with a lightning discharge member, a lightning conductor that extends from the lightning discharge member to guide lightning-strike current to ground, and an optical-fiber current sensor that is provided on the lightning conductor, detects the lightning-strike current flowing in the lightning conductor, and outputs an optical signal, the lightning-strike detecting method comprising:
an optical signal conversion step that receives the optical signal, converts the optical signal to an electrical signal, and outputs the electrical signal; and
a control step that receives the electrical signal, detects a lightning strike, and informs a manager of a lightning strike.

17. A lightning-strike detection program for a lightning-strike detecting apparatus equipped with a lightning discharge member, a lightning conductor that extends from the lightning discharge member to guide lightning-strike current to ground, and an optical-fiber current sensor that is provided on the lightning conductor, detects the lightning-strike current flowing in the lightning conductor, and outputs an optical signal, the lightning-strike detection program executing:
optical signal conversion processing that receives the optical signal, converts the optical signal to an electrical signal, and outputs the electrical signal; and
control processing that receives the electrical signal, detects a lightning strike, and informs a manager of a lightning strike.
